(19) United States
(12) Patent Application Publication
(10) Pub. No.: US 2007/0174142 A1
(43) Pub. Date: Jul. 26, 2007

(54) Method for increasing the efficiency of drive through businesses

(76) Inventor: Waldemar F. Kissel JR., Gainesville, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/598,209

(22) Filed: Nov. 10, 2006

Related U.S. Application Data
(60) Provisional application No. 60/736,122, filed on Nov. 11, 2005.

(51) Int. Cl. G06Q 30/00

(52) U.S. Cl. 705/27

(57) ABSTRACT

Disclosed is a method for increasing the efficiency and speed of operations at businesses with drive through windows and extends feasibility of this facility to additional business enterprises. The method includes providing a series of ordering bays that are located at a distance from the business. A driver pulls up to one of the bays and enters an order via a cellular telephone and an order screen. From the bay the driver can order items from one of several adjacent businesses. The driver can then pull forward to a pick up window to retrieve the order. If further time is needed, the driver can wait in a nearby parking space. The entire method is carried out with a traffic pattern that efficiently routes traffic to avoid back ups.

### DESCRIPTION OF RELATED APPLICATIONS

This application claims benefit from co-pending provisional application Ser. No. 60/736122 filed on Nov. 11, 2005, the contents of which are incorporated herein by reference.

### BACKGROUND OF THE INVENTION

1. Field of the Invention

This invention relates to an improved ordering system for restaurants and businesses that offer drive through services, and extends the applicability and practicality of drive up service to additional business models.

2. Description of the Background Art

Few business structures are as aesthetically unpleasing as a fast food drive-in restaurant. Only gas stations and auto repair garages rank lower. Customers entering a restaurant with a busy drive-in window may feel like a turtle trying to cross a highway.

Drive-in restaurants have overwhelmingly proven their merit; however drive-in restaurants use a lot of space. Present drive-up window service arrangements are awkward, bottlenecked and appear contrived. Drive-up service is convenient and could be more widespread if service could be faster.

Drive-up restaurant windows in their present form lend themselves well to certain types of food service where the food preparation is simple and fast. It does not work well in those situations where the preparation time is much longer than the time it takes to place an order and pay at a window. Cars tend to back-up. These businesses do not usually do a lot of drive-up business because it takes too long to prepare an order. These types of restaurants include barbeque restaurants, sub shops, pizza parlors, and ice cream stores and any other restaurant that is quasi fast food and quasi sit in nature.

Typically the drive-up window ordering process is like this. The customer drives in and stops at an outside speaker and screen. The order is taken and confirmed on the screen. The customer is told to drive to the first window. There the order is paid for. Then the customer drives to the next window where the customer receives the order, or waits until the order is ready. Or a customer stops at one window, orders, pays, waits and receives the order all at one window. Other drive-up customers wait through the entire transaction. In the improved system described here, there are several interactive windows available for placing and paying for orders.

### SUMMARY OF THE INVENTION

It is therefore an objective of this invention to provide a method for improving the efficiency and speed of drive through businesses.

It is another objective of this invention to provide a method for improving the traffic flow for businesses with drive through services.

It is also an object of this invention to enable drive through restaurants to rapidly and efficiently fill orders.

Still another object of this invention is to increase drive through business volume by allowing a series of drive through businesses to work together.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a depiction of the preferred drive though business method of the present invention.

FIG. 2 is a depiction of an alternative drive through business method of the present invention.

FIG. 3 is a depiction of an alternative drive through business method of the present invention.

FIG. 4 is a depiction of an alternative drive through business method of the present invention.

FIG. 5 is a depiction of an alternative drive through business method of the present invention.

FIG. 6 is a depiction of an alternative drive through business method of the present invention.

FIG. 7 is a depiction of an alternative drive through business method of the present invention.

FIG. 8 is a depiction of an alternative drive through business method of the present invention.

FIG. 9 is a depiction of an alternative drive through business method of the present invention.

FIG. 10 is a depiction of an alternative drive through business method of the present invention.

Similar reference characters refer to similar parts throughout the several views of the drawings.

### DETAILED DESCRIPTION OF THE PREFERRED EMBODIMENT

The present invention is a method for increasing the efficiency and speed of operations at businesses with drive through windows. The method includes providing a series of ordering bays that are located at a distance from the businesses. A driver pulls up to one of the bays and enters an order via a cellular telephone and an order screen. From the bay the driver can order items from one of several adjacent businesses. The driver can then pull forward to a pick up window to retrieve the order. If further time is needed, the driver can wait in a nearby parking space. The entire method is carried out with a traffic pattern that efficiently routes traffic to avoid back ups. The various features of the present invention are described in greater detail hereinafter.

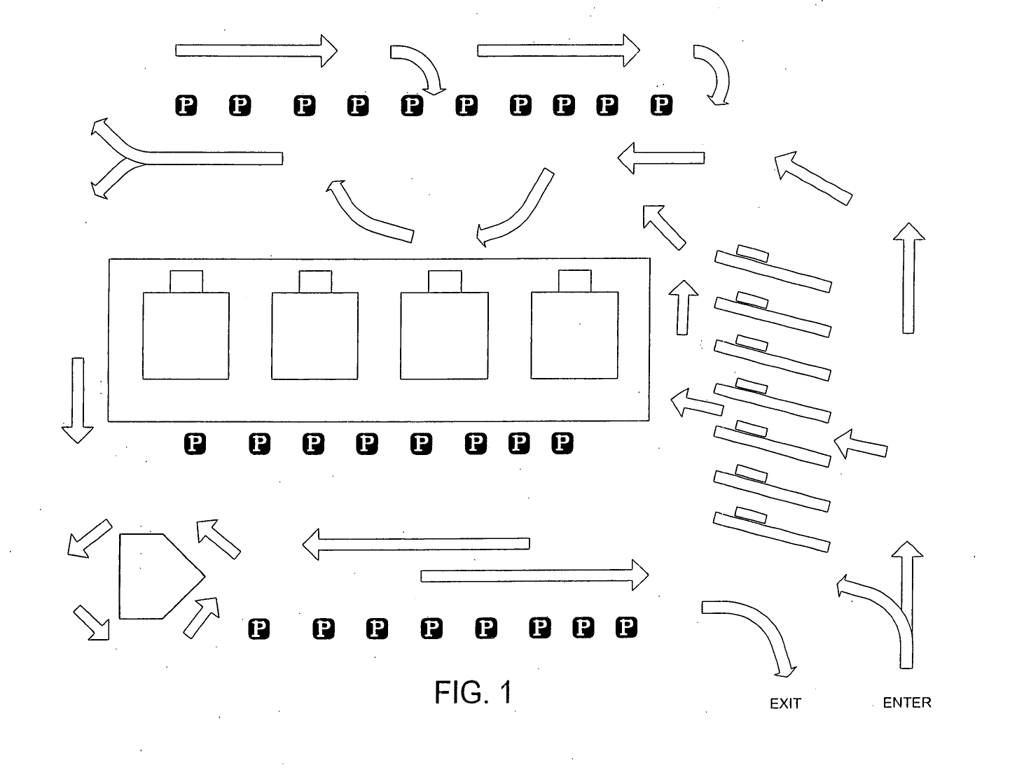

FIG. 1 illustrates a row of four restaurants. However, the present invention can just as easily be carried out with any number of restaurants, such as six. These restaurants have substantial indoor seating and tables, and may even have waiter service. Between the buildings and in front, each restaurant can have a landscaped courtyard with tables, umbrellas and trees for comfortable outdoor dining.

These restaurants offer a window service. As cars turn into the driveway a large sign points customers who want to park and enter the restaurants to turn left. However, for drive-in window orders the sign points drivers to drive straight ahead.

In FIG. 1 there are seven ordering bays for cars to enter. Again, the exact number of bays provided is unimportant and other numbers can be employed. Upon entering a bay the driver stops at the ordering window. A large screen (and voice) instructs the driver to enter a regular 7 digit phone number on their cellular phone (or put it on speed dial and press 1 or 2 numbers). When the number answers the screen lists all four restaurants with a number.

The customer enters the number beside the restaurant. That menu appears. The menu could be organized in many ways. All selections are made by number. When finished ordering from that restaurant menu the customer may select other restaurant menus from any of the four restaurants. When finished ordering the entire order is visible on a larger monitor screen and may be read back for verification. If the order is not correct the customer can scroll to the item number and delete or correct.

If the order is correct the customer may pay by entering his credit card number from the cell phone and the cell phone number or pay by cell phone. The customer may be asked to verbally provide name, address, zip code or phone number or provide a fingerprint scan. This would be recorded with the credit card information. In future visits the customer may pay with a fingerprint scan. The customer would be given an order number and receipt and asked to pull forward to the next station just one car length ahead to wait (this pulling forward to wait is an optional step). When a customer order is ready or nearly ready the order number would be called out at that station and the driver instructed to pull forward to PICK-UP window number 1, 2, 3, or 4. The pick-up window can be at any restaurant depending upon window availability. A light conveyor belt system running both directions carries packaged food orders between restaurants to a designated window. Orders that are prepared for delivery to the customers would be a separate designation station (perhaps at the end of the belt).

If a particular order will take a while to prepare, or if one restaurant usually needs a few minutes to prepare the order, the customer will be asked to pull forward into a numbered parking space and the order will be brought out to the customer. Some restaurants may elect to handle all drive-up customers that way.

In a similar way, customers with carryout menus in their possession could dial ahead and place their order and get assigned an order number so the order is ready upon arrival.

To make a system like this work requires a developer to build this cooperative window service into the leasing agreements.

Most local governments require an area set aside for tractor trailers to make deliveries. An additional advantage of this invention is that tractor trailers can park at individual pick-up windows to make deliveries without disrupting traffic flow, or other businesses. Even the business receiving delivery from a tractor trailer can continue to serve customers at other windows.

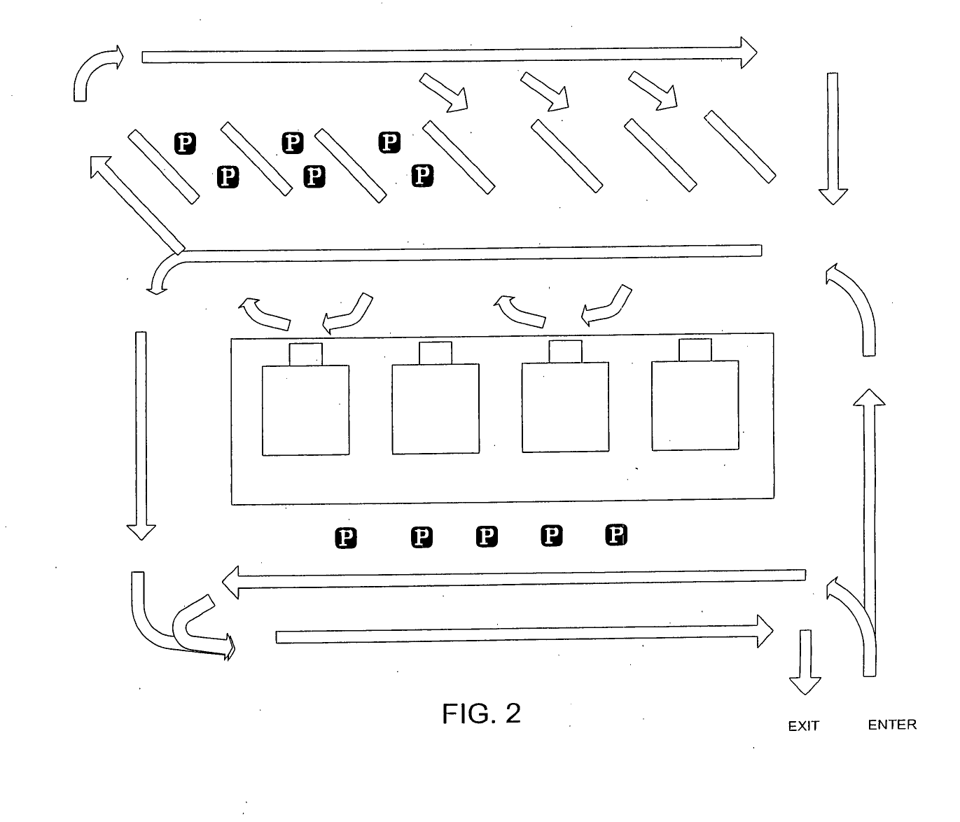

FIG. 2 is another driveway arrangement but is the same concept. That is there is a bank of several drive-up order stations. Any order station can be used for ordering from any restaurant. There is no waiting for a window service person to take your order. The order goes direct to the kitchen as soon as it is verified and paid for by the customer. The only necessary human involvement is handing the food to the customer. The customer should be told if there is going to be a delay. Entertainment could even be shown on the order screen.

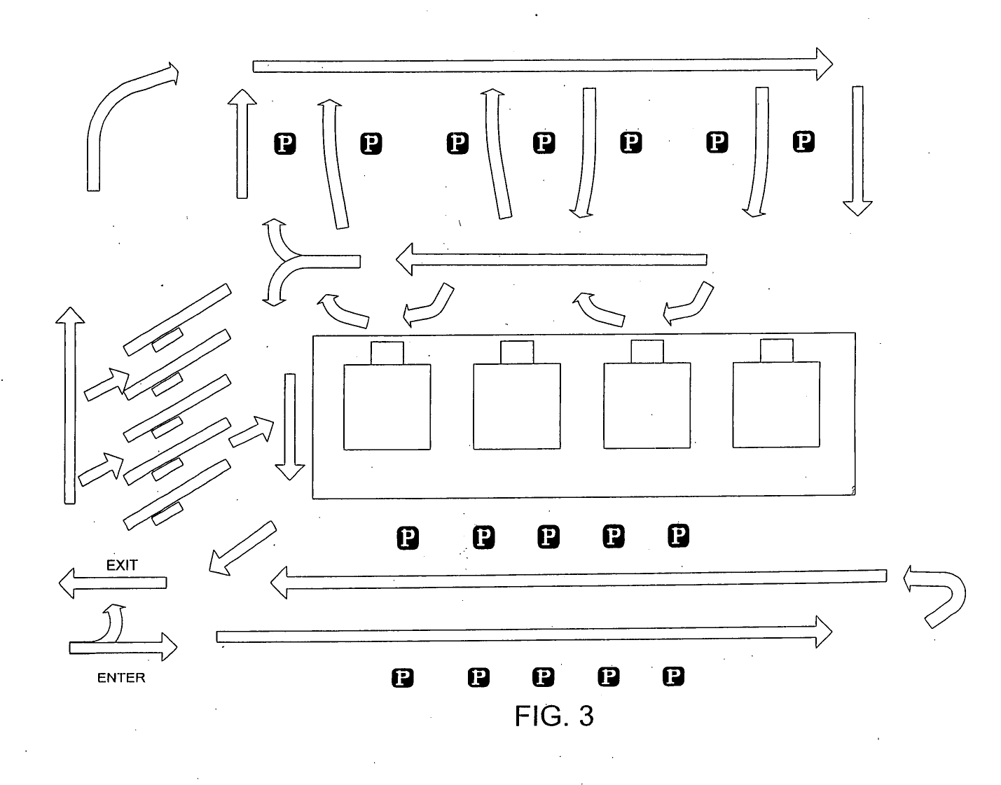

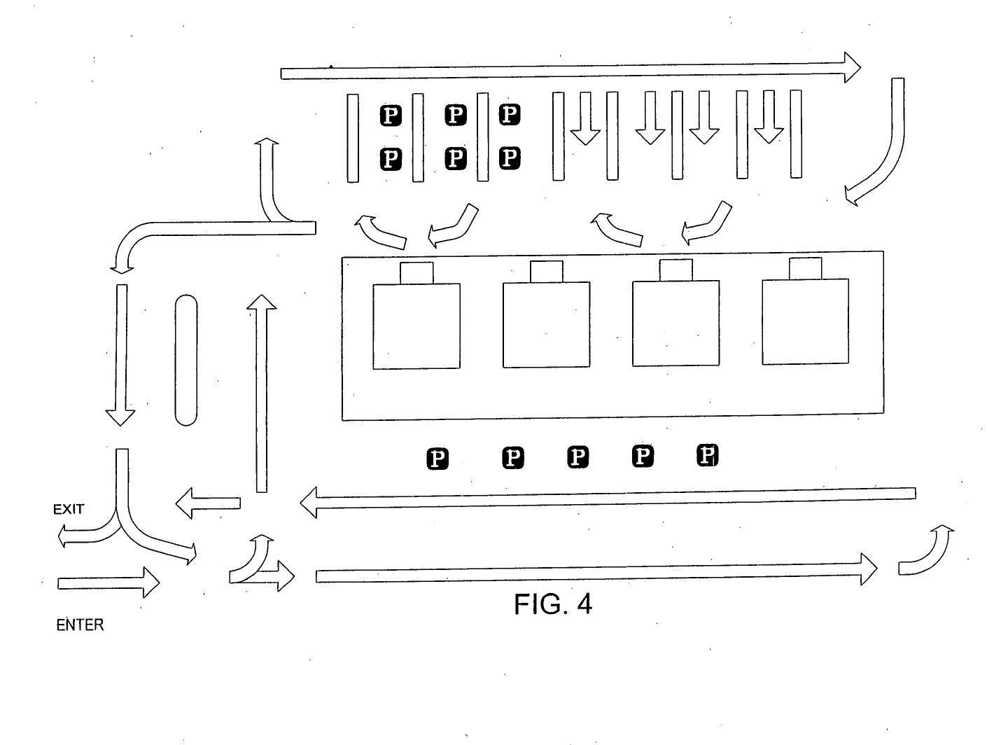

FIGS. 1 and 2 show the situation for when the entering driveway is on the right. FIGS. 3 and 4 show a typical situation for when traffic is entering from the left. FIG. 3 shows order windows on the end with lots of optional parking in the back. FIG. 4 shows the ordering windows in the back of the restaurants.

FIGS. 2 and 4 are preferred embodiments because they keep all the drive-in window activity completely concealed. The four restaurants look like free standing buildings. They occupy less space. They are safer for the customers who want to drive-in to eat in the restaurant or on the patio. The window service requires no waiting. Each restaurant is still in control of its own service. If an order involves more than one restaurant, all the restaurants could be preparing food simultaneously for the customer, it is paid for on one tab as if it were one restaurant.

If a drive-in customer did not have a cell phone the drive-up window would have a touch screen listing each restaurant or business selection. After selecting a restaurant menu or business service offered, customer places order by touching the proper section and following directions on the screen or from verbal directions. This device would be on a flexible arm of some sort. A credit card can be slid through and signed on screen or alternatively, a fingerprint scan could be used.

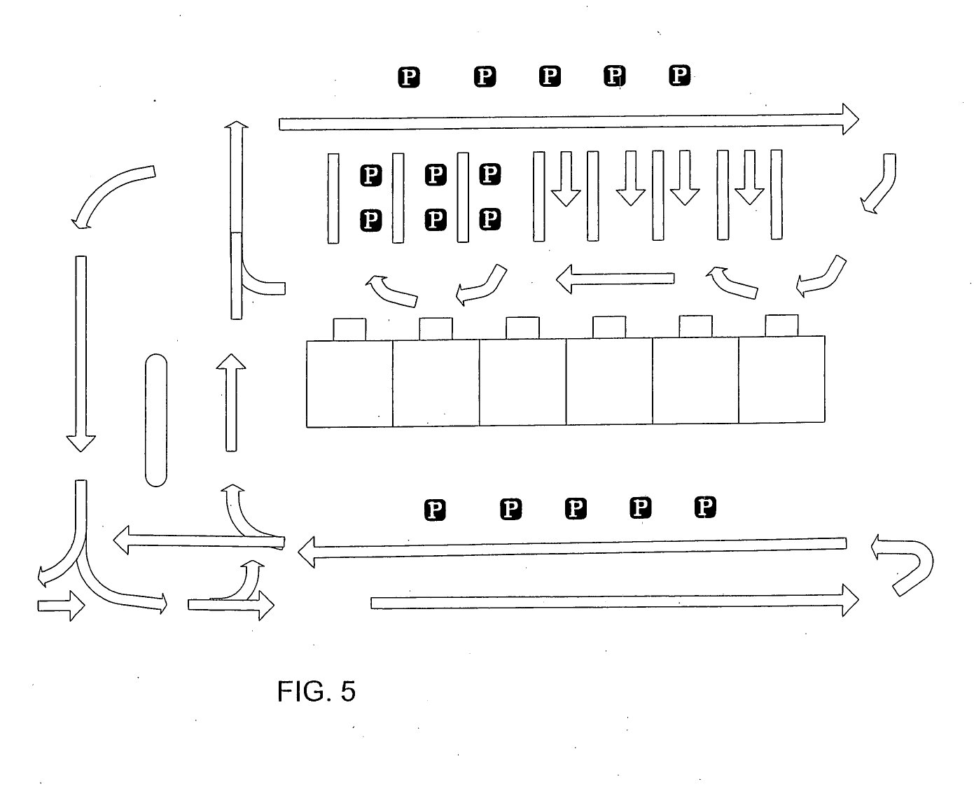

FIG. 5 applies this same innovation concept to a strip shopping center with a mixture of tenants including several restaurants, a pharmacy, dry cleaner, liquor store, shoe repair and alterations, computer repair, copy store, postal facility, office supply store or bank (not a full branch).

Drive-up windows can be provided for each retail module so each retail occupant can provide a drive-up window where customers can pick up any merchandise or drop off items for cleaning, alterations, repair, or returns to customer service.

In the front the shopping center could have a clean fashionable appearance, customers may make purchases in some stores that are bulky, heavy, or hard to handle. They can drive around back to a pick-up station.

A strip center with a sub shop, coffee shop, Chinese restaurant, pizza shop, pharmacy and liquor store could offer drive-up window service. Dry cleaners can use the window for pick-up and drop-off, computers can be dropped off for repair, office supplies can be picked up, items can be dropped off for copying and picked up when ready. A UPS Store could have drop-off and window pick-up service. Banks could have small banking offices where people could open checking accounts, make deposits and get cash. Armored trucks could come right up to the window so it would be more secure. Many other businesses can be added to this list.

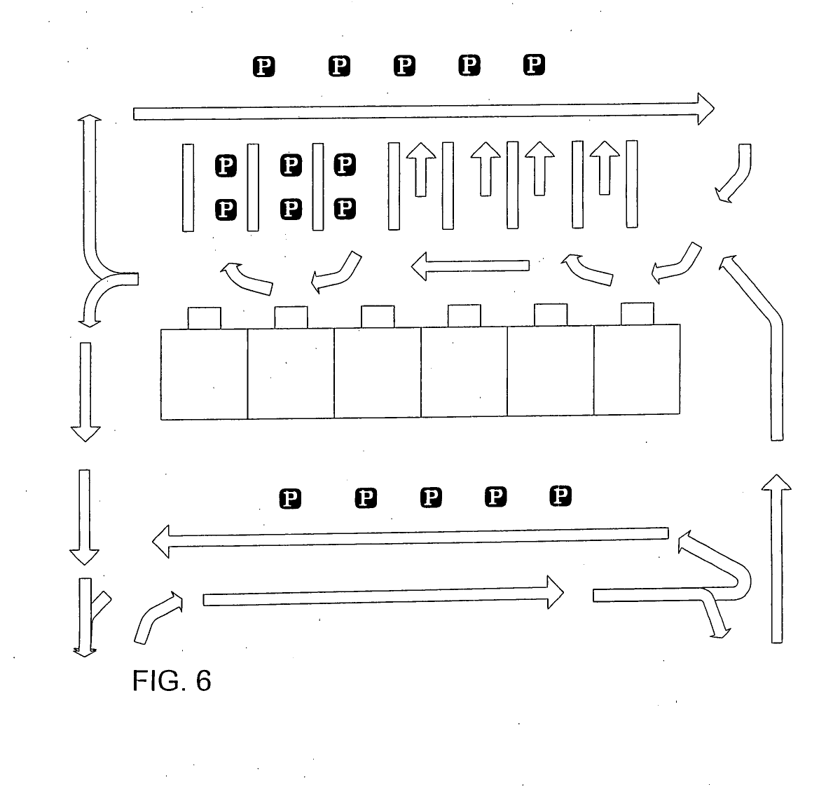

FIG. 6 illustrates an improved traffic flow with drive-in customers entering along the right side of the building(s) and exiting on the left side of the building. This also takes drive-in traffic away from the front walk-in traffic parking area.

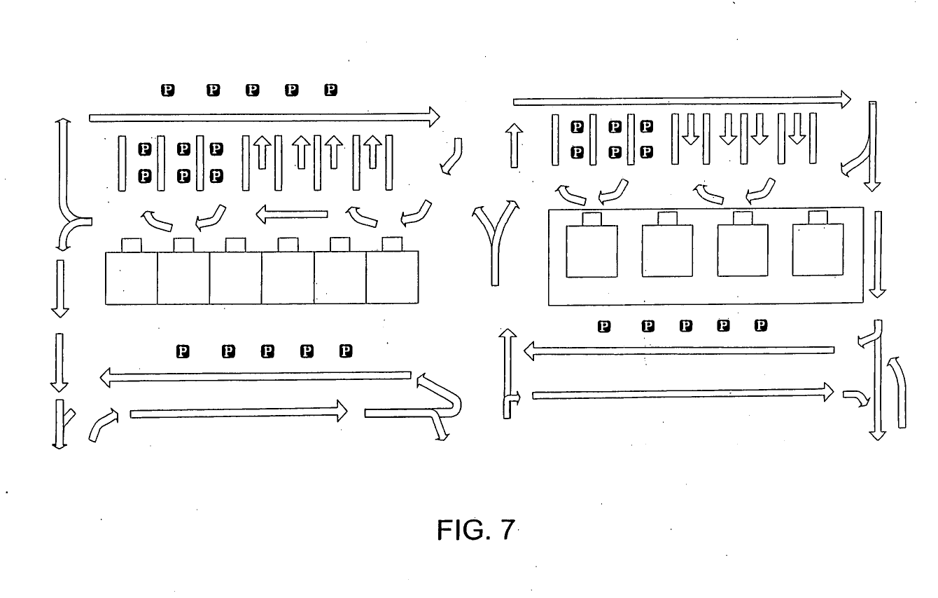

FIG. 7 the concept applied to a combination strip shopping center and detached drive-up restaurants. In this illustration drive-in traffic enters between the strip center and restaurants to allow separation of the traffic and room for vehicles to wait in a line behind order windows if needed.

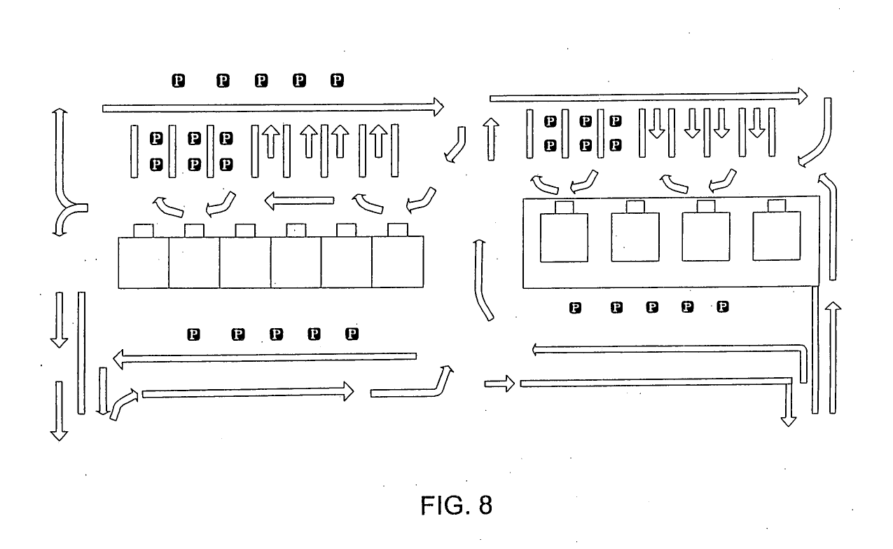

FIG. 8 improves on FIG. 7 by using raised medians to create separate traffic lanes for drive-in traffic on the right and exiting drive-in traffic on the left. Walk-in customers in front of the stores can still drive around back to pick-up merchandise.

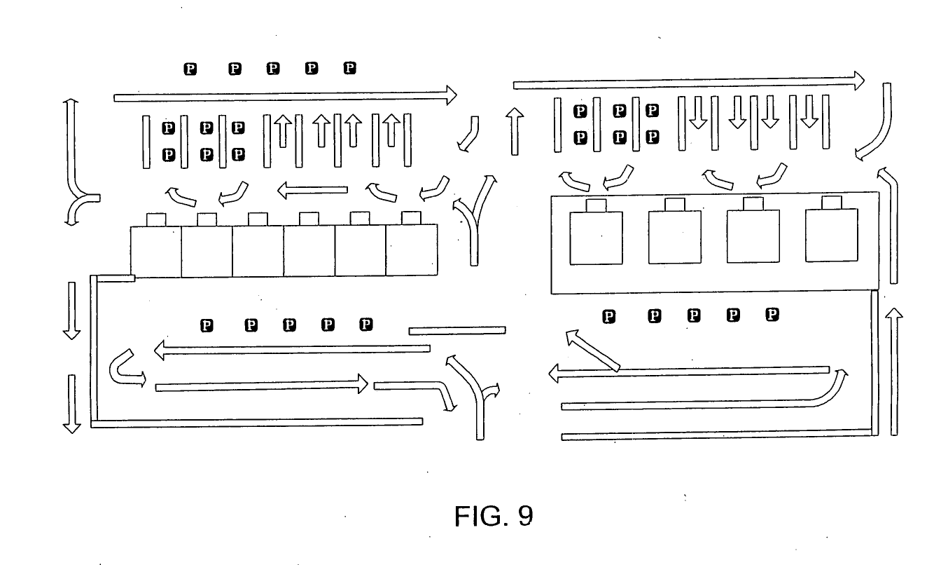

FIG. 9 improves on FIG. 8 by separating the entrance for drive-in traffic and walk-in traffic. The exiting traffic is also separated to minimize confusion.

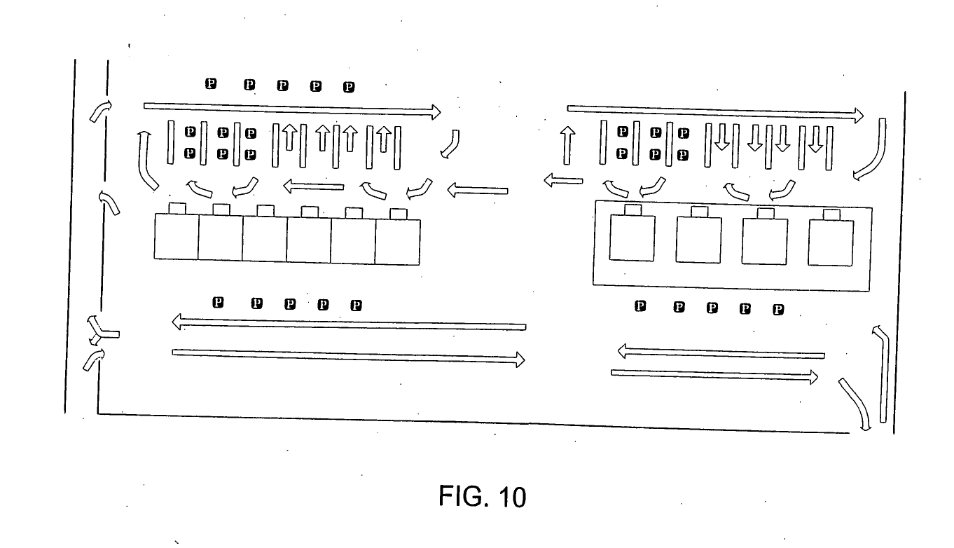

FIG. 10 illustrates an arrangement that could work when there is an entry road alongside the shopping area and restaurants. Drive-in traffic entrance and exit is separate from walk-in traffic entrance and exit. This completely separates the two activities and offers concealment of the less attractive drive-in activity. This offers the ultimate experience in drive-up window service.

The present invention expands the drive-up window far beyond drive-up restaurants. Customers go first to a drive-up window, or can call ahead from the car, office or home to get the transaction set up so there might be less confrontation. Customers can wait in their car where they can read, or do other things while waiting.

The concept of multiple ordering stations can be used even if there is a single restaurant or drive-up window. For example, there could be four windows so cars would not have to wait in line to place and pay for an order. They would be told to pull forward when their order is ready.

The ordering stations could be equipped so either the driver or the right side passenger could place the order.

Order screens could be equipped to extend forward toward a car and stop when contact is made with the vehicle.

The concept described above uses cell phone touch screen or key pads for placing orders. There are a number of other ways for customers to interact with the drive-up interactive station for ordering or communicating with the business on the other end of the line. The windows could use some or all of the following methods depending on preference or type of business transaction, in most cases, the customer should be allowed to initiate the transaction rather than waiting for someone to get around to providing service.

VOICE RECOGNITION ORDERING—Looking at the menu a customer may give a number or letter that identifies the order. As the order is placed the customer's voice is recorded and at the same time voice recognition software interprets the voice into an order. It appears on the screen in print. If it cannot match words with menu items it may ask for a repeat.

After the order is completed the order appears on a screen along with the total price. The customer verifies and can pay by inserting a credit card, if card was not inserted earlier, and receiving a ticket to sign, or by cash. If cash, the money could be sent by vacuum tube back to the cashier for change and receipt. The business may have one cashier for each stall or one cashier for all stalls.

In the present described process, suppose the customer has a heavy accent. The cashier, listening on the other end, may intervene by asking the customer to please wait while she/he reviews the order. That is where the recorded record of the order comes in. The cashier does not necessarily have to ask the customer to repeat the order, she/he can listen to the tape and verify each item with the customer. After order is verified for accuracy and paid for a pick-up window number and order number is printed boldly on the receipt to the customer, the cashier, the person in charge of preparing orders, the window where the order will be picked-up, and a copy to staple on the order itself. Some of these paper receipts could be placed on computer screens depending on the type of business and how it is organized. If all drive-up windows are occupied the customer would wait in the stall until a pick-up window number was available or until the order is ready.

In the remaining scenarios only the unique order process will be described. The complete mechanics of order processing will be similar to those above.

TOUCH SCREEN ORDERING. The customer would touch ORDER #1 for the first order, then a menu would come up such as Hamburger, Cheeseburger, Roast Beef, Chicken, or Fish. After touching the selection, a choice of sandwich or combo comes up. If Hamburger—sandwich is selected, the next choice could be jr, regular, quarter pound, double, triple. The next choice would provide for multiple choice pickles, onions, ketchup, mustard, mayonnaise, lettuce, tomato. If a combo were selected there would be all of that and then choice of fries, choice of drink, choice of upsizing. Then a choice of any options such as cup of cheddar cheese or chili and condiments salt, pepper, ketchup, mustard, salsa. Then a screen for deserts. A screen for next order or order complete. This process could be slow but it is very easy for customer to use and very accurate. In this one transaction a customer could order from several restaurants and pick up the order at one window.

VOICE PROMPT—QUESTION & ANSWER. In this order process the customer would press a button next to the item on the menu or alternatively could verbally state what the item is.

The voice prompt would repeat the selection and ask if that is correct, yes or no. If no the voice prompt would ask customer to press the button with his selection again. If yes the voice prompt goes onto the next obvious question. For example an order at ARBY's® would go like this. Customer says giant roast beef. The voice prompt repeats and confirms. The voice prompt asks sandwich or combo, after hearing selection it repeats the word combo and waits for yes or no. Then it asks choice of fries, regular or curly, repeats customer answer and waits for yes. Choice of drink, waits for answer, repeats and waits for yes. Voice prompt asks horsey sauce, Arby sauce or mayonnaise. Waits for answer, repeats and waits for a yes. The voice prompt is the way many cashiers are trained except this would be an electronic cashier.

PRESS and ENTER. Another fundamental way to place an order is for the customer to press a button beside each menu item and press an enter key after each selection. Press delete key to change mind. Press total to complete order. Good for a simple menu.

TRADITIONAL ORDERING. Another way is the way it is done now. Talk to a cashier who takes the order, and collects payment. The advantage is several orders can be taken at once. The disadvantage is it requires a cashier for each stall and increases the chance for error.

DIRECT ORDERING. A final order placement procedure is for certain businesses where the order is actually prepared by the person taking the order. This cannot be done with current drive-up restaurant windows. In this scenario one person would man the several windows and that person's job would be to see that customers were served in the order they arrive and also to assign orders to a particular server. The servers are wearing wireless headphones and are patched through to the customer. Examples are Cold Stone Creamery® and Subway®.

At Cold Stone Creamery® the customer selects an ice cream flavor, then a size, then a cup, cone or bowl, then a flavored cone or bowl, waffle or sugar, then there are mix-ins. When finished it is ready for pick-up. Here the server may specify a window and step to the window to collect payment and deliver the order. In some situations such as a Subway®, a sandwich ingredient assembly bar could be placed away from the front order line and could be accessed by servers making sandwiches on both sides of the sandwich ingredient assembly bar. This would allow sandwich makers to continue as they do now, but allow another set of sandwich makers and cashiers to work on the other side for the window pick-up. Subway® could do a lot more business in the same space.

This complete disclosure is claimed as an element readily applied to the Automated Transport System described by ASI-ATS (American Standards Institute for Automated Transport Systems).

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for increasing the efficiency and speed of drive-through businesses, the method allowing a customer in a vehicle to place and retrieve orders from a plurality of adjacent drive-through businesses, each of the drive-through businesses having an associated list of available items for purchase, the method employing a series of ordering bays that are located at a distance from the plurality of drive-through businesses, wherein each of the ordering bays has a display screen and a speaker that allow the customer to place orders via a cellular phone, the method comprising the following steps:
directing the customer to drive his or her vehicle to one of the ordering bays;
instructing the customer via the display screen to dial a specified phone number;
listing the plurality of drive-through businesses on the display screen in response to the customer dialing the specified phone number and associating a number with each listed drive-through business;
selecting a drive-through business from the plurality of listed drive-through businesses;
displaying on the display screen the list of available items for purchase from the selected drive-through business and associating a number with each listed item;
selecting a listed item from the list of available items in response to the customer dialing the associated number;
repeating the above steps to allow the customer to select additional drive-through businesses and further select from the associated list of available items;
displaying the all of the selected items and verbally communicating the selected items via the speaker for verification;
accepting customer payment information from the cellular telephone and providing an order number and receipt;
moving selected items from associated drive-through businesses to a designed drive through business;
instructing the customer by way of the order number to drive to the designated drive-through business;
delivering the selected items to the customer at the designated drive-through business.

2. A method for increasing the efficiency and speed of drive-through businesses, the method allowing a customer in a vehicle to place and retrieve orders from a plurality of adjacent drive-through businesses, each of the drive-through businesses having an associated list of available items for purchase, the method comprising the following steps:
instructing the customer to dial a specified phone number;
listing the plurality of drive-through businesses on a display screen in response to the customer dialing the specified phone number and associating a number with each listed drive-through business;
selecting a drive-through business from the plurality of listed drive-through businesses;
displaying on the display screen the list of available items for purchase from the selected drive-through business and associating a number with each listed item;
selecting one or more listed items from the list of available items in response to the customer dialing associated numbers;
accepting customer payment information and providing an order number and receipt;
delivering the selected items to the customer at a designated drive-through business.

3. The method as described in claim 2 wherein the ordering is accomplished at one of a number of ordering bays that are located at a distance from the drive through businesses.

4. The method as described in claim 2 wherein the list of selected items is verbally communicated to the customer for verification purposes.

5. The method as described in claim 2 wherein selected items are moved from associated drive-through businesses to a designed drive through business for delivery to the customer.

6. The method as described in claim 2 wherein the method allows the customer to order a variety of items from a number of different drive-through businesses and wherein all of the items are delivered to a single drive-through business for pick up by the customer.

7. A method for increasing the efficiency and speed of drive-through businesses, the method allowing a customer in a vehicle to place and retrieve orders from a plurality of adjacent drive-through businesses:
listing the plurality of drive-through businesses on a display screen and associating a number with each listed drive-through business;
selecting a drive-through business from the plurality of listed drive-through businesses;
displaying on the display screen the list of available items for purchase from the selected drive-through business and associating a number with each listed item;
selecting one or more listed items from the list of available items in response to the customer dialing associated numbers;
repeating the steps whereby the customer selects other items for purchase from other drive-through businesses;
delivering all of the selected items to the customer at a single drive-through business.
